(19) United States
(12) Patent Application Publication
(10) Pub. No.: US 2022/0050826 A1
(43) Pub. Date: Feb. 17, 2022

(54) NON-TRANSITORY COMPUTER-READABLE STORAGE MEDIUM FOR STORING COMMUNICATION PROGRAM, COMMUNICATION METHOD, AND COMMUNICATION APPARATUS

(71) Applicant: FUJITSU LIMITED, Kawasaki-shi (JP)

(72) Inventor: Junichi Suga, Ota (JP)

(73) Assignee: FUJITSU LIMITED, Kawasaki-shi (JP)

(21) Appl. No.: 17/336,372

(22) Filed: Jun. 2, 2021

(30) Foreign Application Priority Data
Aug. 17, 2020 (JP) 2020-137223

(51) Int. Cl. G06F 16/23; G06F 21/62

(52) U.S. Cl. CPC G06F 16/2379; G06F 2221/2141; G06F 21/62

(57) ABSTRACT

A non-transitory computer-readable storage medium storing a communication program for causing a computer to execute processing, the processing including: managing an update status of data owned by a data-owning apparatus; managing an acquisition status of the data acquired by a data-using apparatus through the data-owning apparatus; determining, when a data acquisition request from the data-using apparatus is detected, whether the data-using apparatus has acquired updated data that has been updated, based on the update status and the acquisition status; and issuing an access permission for acquiring the updated data to the data-using apparatus in a case where it is determined that the data-using apparatus has not acquired the updated data.

### CROSS-REFERENCE TO RELATED APPLICATION

This application is based upon and claims the benefit of priority of the prior Japanese Patent Application No. 2020-137223, filed on Aug. 17, 2020, the entire contents of which are incorporated herein by reference.

### FIELD

The embodiments discussed herein are related to a non-transitory computer-readable storage medium storing a communication program, a communication method, and a communication apparatus.

### BACKGROUND

In recent years, personal data has been distributed between enterprises, and new services and businesses are expected to be created by promotion of a personal data distribution.

As a distribution form of the personal data, for example, a centralized data distribution form represented by an information bank is known in Japan. In this technology, personal data owned by a plurality of enterprises is collected and accumulated in a specific platform, and the personal data is distributed to other enterprises with a personal consent.

On the other hand, a decentralized data distribution form in which personal data is mutually used and the data is distributed between enterprises is attracting attention. In the decentralized data distribution form, personal data is distributed from an enterprise that owns the personal data to another enterprise who wants to use the personal data. In the case of the decentralized type data distribution form, personal data is not accumulated in a specific platform, so that data management costs may be reduced.

As a decentralized data distribution form, application of a user managed access (UMA) protocol (for example, UMA 2.0) has been studied. A UMA is a protocol that implements transfer of personal data from a data owner to a data user by having an environment in which a “data owner” who owns personal data, a “data user” who uses the personal data, and a “person” who is an owner of the personal data are separated from each other.

As a technique related to a data distribution, for example, a technique has been proposed in which an information possessing subject searches for a content entity corresponding to a requested content, extracts a presentation use condition forming a pair with the content entity, and determines permission or refusal of usage from the presentation usage conditions and usage rules. Further, there has been proposed a technique for displaying an information access screen including an area in which a keyword input field for acquiring information related to a keyword input from a terminal is disposed and an area in which a character and an image to which a link for acquiring personal information is set is disposed.

Examples of related art include Japanese Laid-open Patent Publication Nos. 2000-357195 and 2002-259416.

### SUMMARY

According to an aspect of the embodiments, there is provided a non-transitory computer-readable storage medium storing a communication program for causing a computer to execute processing. In an example, the processing includes: managing an update status of data owned by a data-owning apparatus; managing an acquisition status of the data acquired by a data-using apparatus through the data-owning apparatus; determining, when a data acquisition request from the data-using apparatus is detected, whether the data-using apparatus has acquired updated data that has been updated, based on the update status and the acquisition status; and issuing an access permission for acquiring the updated data to the data-using apparatus in a case where it is determined that the data-using apparatus has not acquired the updated data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a communication apparatus;

FIG. 2 illustrates an example of a communication sequence of a UMA;

FIG. 3 illustrates an example of a secondary distribution of personal data;

FIG. 4 illustrates an example of a data distribution network;

FIG. 5 illustrates an example of functional blocks of a consent portal;

FIG. 6 illustrates an example of a hardware configuration of a consent portal;

FIG. 7 illustrates an example of a personal data update status management table;

FIG. 8 illustrates an example of a personal data acquisition status management table;

FIG. 9 is a flowchart illustrating an example of an operation of generating a personal data transfer route;

FIG. 10 illustrates an example of a personal data transfer route;

FIG. 11 is a flowchart illustrating an example of an operation of generating a request route;

FIG. 12 illustrates an example of a request route;

FIG. 13 illustrates an example of a communication sequence;

FIG. 14 illustrates an example of a communication sequence;

FIG. 15 illustrates an example of a communication sequence in a UMA;

FIG. 16 illustrates an example of a communication sequence in a UMA;

FIG. 17 illustrates an example of a communication sequence;

FIG. 18 illustrates an example of a communication sequence;

FIG. 19 illustrates an example of a communication sequence according to a modification example; and

FIG. 20 illustrates an example of a communication sequence according to a modification example.

### DESCRIPTION OF EMBODIMENT(S)

The data user requests personal data to a data owner, and the data owner transmits the requested personal data to a data user. However, in a case where the personal data is not updated, the data user may transmit a request for personal data that the data user has already acquired to the data owner. In this case, there is a problem that communication for an unnecessary request and unnecessary personal data occurs, and communication traffic increases.

According to an aspect of the embodiments disclosed below, there is provided a solution to reduce communication traffic.

Hereinafter, embodiments are described with reference to the drawings.

### FIRST EMBODIMENT

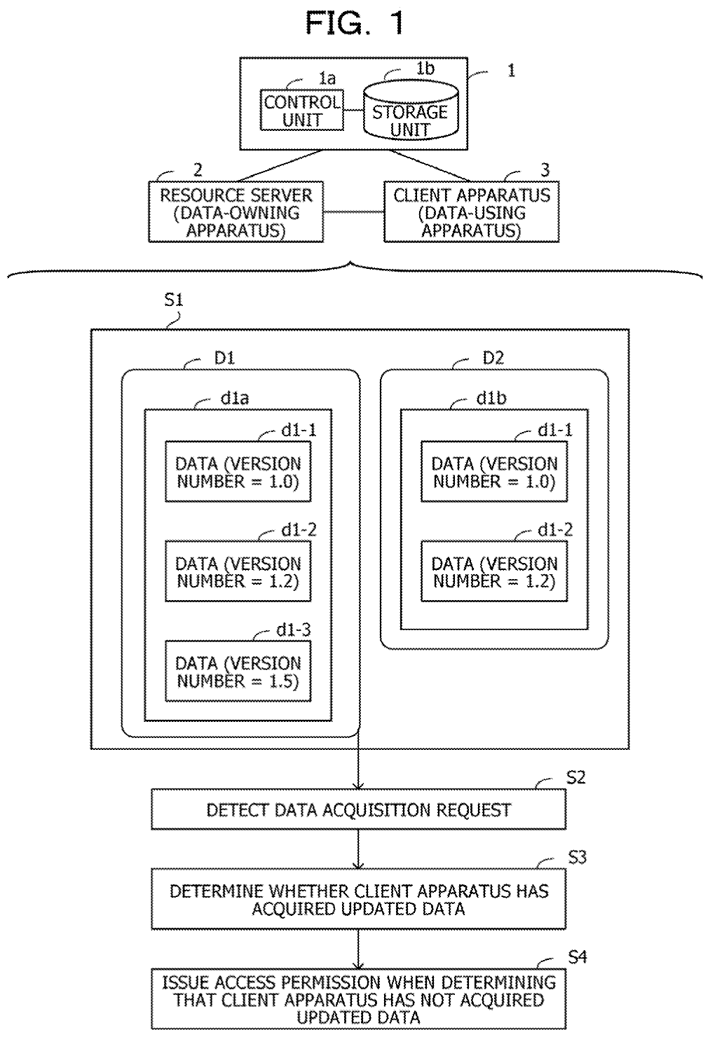

A first embodiment will be described with reference to FIG. 1. FIG. 1 is a diagram illustrating an example of a communication apparatus. A communication apparatus 1 includes a control unit 1a and a storage unit 1b. The communication apparatus 1 is coupled to a resource server 2 (data-owning apparatus) and a client apparatus 3 (data-using apparatus).

The control unit 1a manages an update status of data owned by the resource server 2 and manages an acquisition status of data acquired by the client apparatus 3 through the resource server 2.

In a case where a data acquisition request from the client apparatus 3 is detected, the control unit 1a determines whether or not the client apparatus 3 has acquired updated data that has been updated, based on the update status and the acquisition status.

Then, in a case where it is determined that the client apparatus has not acquired the updated data, the control unit 1a issues an access permission for acquiring the updated data to the client apparatus 3.

The storage unit 1b stores an update status of data of the resource server 2 and an acquisition status of data of the client apparatus 3. Note that a processor (not illustrated) of the communication apparatus 1 implements a function of the control unit 1a by executing a predetermined program.

Operations will be described by using an example illustrated in FIG. 1.

[Step S1] The control unit 1a manages an update status D1 of data of the resource server 2 and an acquisition status D2 of data of the client apparatus 3.

The resource server 2 owns a data group d1a, and the data group d1a includes a data d1-1, d1-2, and d1-3. A version number of the data d1-1 is 1.0, a version number of the data d1-2 is 1.2, and a version number of the data d1-3 is 1.5. The control unit 1a manages, for example, each version number of the data d1-1, d1-2, and d1-3 as the update status D1.

Further, the client apparatus 3 owns a data group d1b, and the data group d1b includes data d1-1 and d1-2. The control unit 1a manages, for example, each version number of the data d1-1 and d1-2 as the acquisition status D2.

[Step S2] The control unit 1a detects a data acquisition request from the client apparatus 3 to the resource server 2.

[Step S3] Based on the update status D1 and the acquisition status D2, the control unit 1a determines whether the client apparatus 3 has already acquired updated data that has been updated. In this example, the client apparatus 3 determines that the client apparatus 3 has not acquired the updated data (data d1-3). For example, the control unit 1a detects that the client apparatus 3 has not acquired the latest data d1-3 of 1.5 version.

[Step S4] A control unit is issues an access permission for acquiring data from the resource server 2 to the client apparatus 3. Accordingly, the client apparatus 3 makes a data acquisition request to the resource server 2 by using the access permission issued from the communication apparatus 1, and acquires the data d1-3 of 1.5 version which is the updated data (latest data).

As described above, the communication apparatus 1 determines whether or not the client apparatus 3 has acquired the updated data based on the update status of data of the resource server 2 and the acquisition status of data of the client apparatus 3.

Then, in a case where the client apparatus 3 determines that the updated data has not been acquired, the communication apparatus 1 issues an access permission for the data acquisition request to the client apparatus 3. Note that in a case where it is determined that the client apparatus 3 has acquired all the updated data, the communication apparatus 1 does not issue the access permission for the data acquisition request to the client apparatus 3.

As described above, in a case where the data has not been updated, it is possible to suppress an operation in which the client apparatus 3 transmits a data request (data acquisition request) of data already acquired by the client apparatus 3 to the resource server 2. Therefore, since it is possible to suppress an occurrence of unnecessary data request and unnecessary data communication, it is possible to reduce communication traffic.

(General Operation and Problems of UMA)

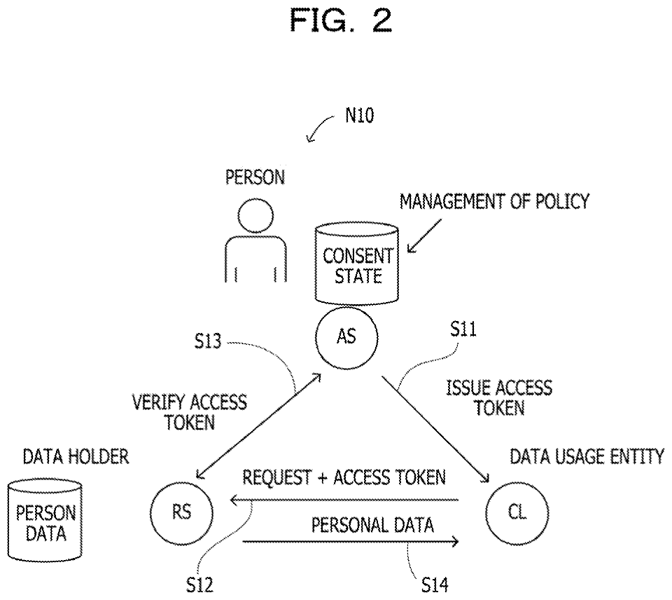

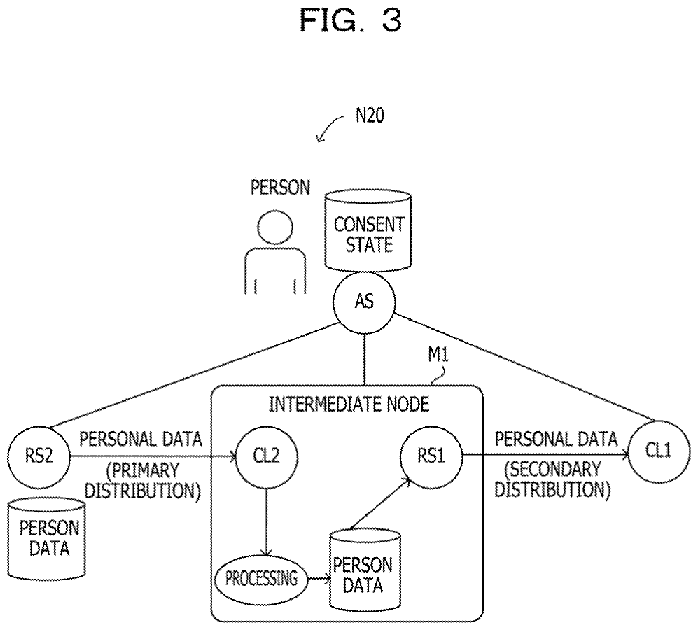

Next, prior to the detailed description of the present disclosure, a general operation of a UMA and problems thereof will be described with reference to FIGS. 2 and 3. FIG. 2 illustrates an example of a communication sequence of a UMA. A data distribution network N10 includes three nodes. Each node is referred to as a resource server (Resource Server: RS), a client apparatus (Client: CL), and an authorization server (Authorization. Server: AS), and are coupled to each other.

A resource server RS corresponds to a “data holder (data owner)” that owns personal data, and a client apparatus CL corresponds to a “data user” that uses the personal data. Further, an AS corresponds to a “person” who is an owner of the personal data. In the following, it is noted that the data user may be referred to as a data usage entity. An entity is a subject of activities, such as a person or an enterprise.

[Step S11] The authorization server AS manages an access policy (a policy for authenticating a user who wants to use personal data) for data access of the client apparatus CL, and issues an access token (corresponding to an access permission) to the client apparatus CL to be permitted.

[Step S12] The client apparatus CL transmits the acquired access token and a data request (hereinafter, may be simply referred to as a request) to the resource server RS.

[Step S13] Upon receiving the request and the access token, the resource server RS inquires of the authorization server AS the acquired access token.

[Step S14] When the resource server RS recognizes that the access token is determined as a valid access token as a result of a verification of the access token by the authorization server AS, the resource server RS transmits personal data to the client apparatus CL.

As described above, in a communication sequence of the UMA, the access policy managed by the authorization server AS and a personal consent are linked to each other, so that a decentralized personal data distribution environment based on the personal consent may be realized.

FIG. 3 illustrates an example of a secondary distribution of personal data. In a distribution of personal data, multi-level distribution (secondary distribution, tertiary distribution, and the like) may be performed. For example, in the secondary distribution, a “data usage entity” that has acquired personal data performs coupling and processing of the personal data, and then distributes the personal data to another “data usage entity” as a “data holder”. In such a multi-level distribution, there exist intermediate nodes (intermediate apparatuses) having functions of both a data usage entity and a data holder.

A data distribution network N20 is an example of a network in which an intermediate node M1 exists. The data distribution network N20 includes an authorization server AS, a resource server RS2, a client apparatus CL1, and an intermediate node M1. The resource server RS2 is coupled to the intermediate node M1, and the intermediate node M1 is coupled to the client apparatus CL1. Further, the authorization server AS is coupled to the resource server RS2, the intermediate node M1, and the client apparatus CL1.

The intermediate node M1 acquires personal data from the resource server RS2, processes the personal data, and provides the processed personal data to the client apparatus CL1. As described above, since the intermediate node M1 acquires the personal data from the resource server RS2, the intermediate node M1 has a function of a client apparatus CL2 as a “data usage entity”. Further, since the intermediate node M1 transmits the processed personal data to the client apparatus al, the intermediate node M1 has a function of a resource server RS1 as a “data holder”.

Note that a distribution of personal data from the resource server RS2 to the intermediate node M1 is a primary distribution, and a distribution of the personal data from the intermediate node M1 to the client apparatus CL1 is a secondary distribution.

The following problems occur in the UMA as described above.

1) Even though the client apparatus CL (final data usage entity) requests personal data and the request is transferred to the resource server RS via the intermediate node, there is a possibility that the client apparatus CL is in a status where the personal data already acquired by the client apparatus CL has not been updated.

In this status, since the acquired personal data which has not been updated is transmitted to the client apparatus CL, there is a problem that the data request and the personal data transferred by the data request are wasted, and communication traffic increases.

2) In the secondary distribution, in order for the client apparatus CL to acquire the latest personal data, the client apparatus CL requests personal data owned by the intermediate node. In response to the request from the client apparatus CL, the intermediate node makes a request to a next intermediate node or a next data holder.

In this case, the intermediate node operates as a “data holder (RS)” at a certain time point, and operates as a “data usage entity (CL)” at a certain time point. For example, the intermediate node communicates with the authorization server AS as the role of the resource server RS, and also communicates with the authorization server AS as the role of the client apparatus CL.

In this manner, when the intermediate node operates the functions of the resource server RS and the client apparatus CL independently and communicates with the authorization server AS, communication traffic between the intermediate node and the authorization server AS increases.

The present disclosure has been made in view of these points, and aims to reduce the communication traffic in the decentralized data distribution form.

### SECOND EMBODIMENT

Next, a second embodiment in which the functions of the communication apparatus 1 are applied to a decentralized data distribution will be described in detail below. Hereinafter, it is noted that the authorization server AS may be referred to as a consent portal. The consent portal is a node (portal site) that has a function of the authorization server AS and manages a personal consent and an access policy.

<Data Distribution Network>

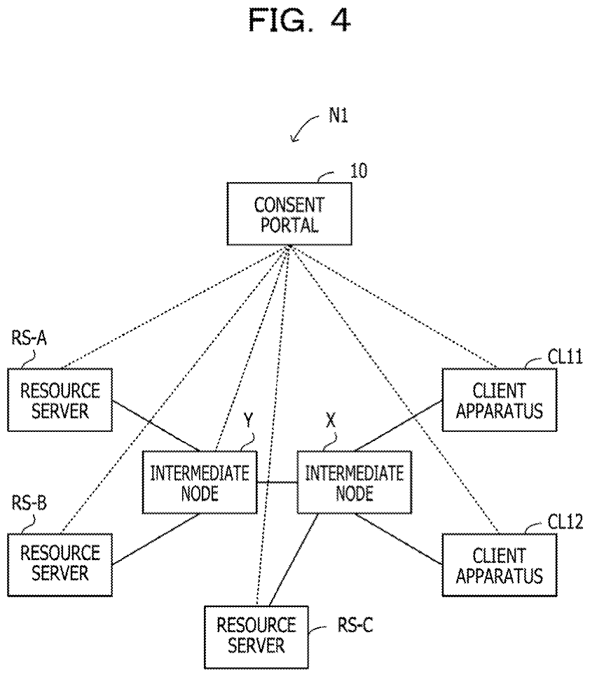

FIG. 4 illustrates an example of a data distribution network. A data distribution network N1 includes a consent portal 10, resource servers RS-A, RS-B, and RS-C, client apparatuses CL11 and CL12, and intermediate nodes X and Y. Note that the consent portal 10 implements the functions of the communication apparatus 1 illustrated in FIG. 1.

The resource servers RS-A and RS-B are coupled to the intermediate node Y, and the intermediate node Y is coupled to the intermediate node X. The intermediate node X is coupled to the client apparatuses CL11 and CL12 and the resource server RS-C. The consent portal 10 is coupled (for example, logically coupled) to the resource servers RS-A, RS-B, and RS-C, the client apparatuses CL11 and CL12, and the intermediate nodes X and Y.

The consent portal 10 manages the resource servers RS-A, RS-B, and RS-C, the client apparatuses CL11 and CL12, and the intermediate nodes X and Y. Further, the consent portal 10 manages a relationship of how personal data is related to the resource servers RS-A, RS-B, and RS-C, the client apparatuses CL11 and CL12, and the intermediate nodes X and Y. For example, the consent portal 10 manages which personal data of which resource server RS is acquired by the intermediate node, which client apparatus CL is provided with the processed personal data by the intermediate node, and the like.

The client apparatuses CL11 and CL12 acquire personal data from the intermediate node X (the intermediate node X is a data holder when viewed from the client apparatuses CL11 and CL12). Further, the intermediate node X acquires personal data from the intermediate node Y (the intermediate node Y is a data holder when viewed from the intermediate node X) and the resource server RS-C.

In the consent portal 10, constituent nodes of the entire data distribution network N1 and the relationships between the personal data and the constituent nodes are grasped.

<Functional Blocks>

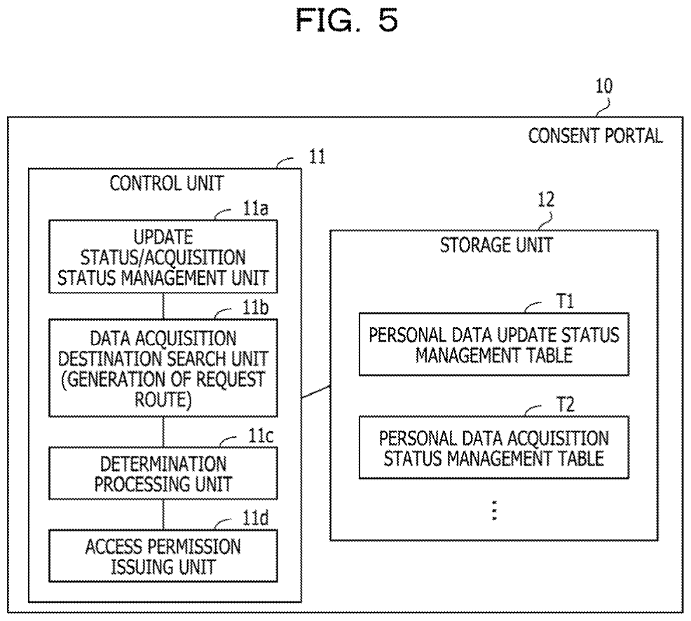

FIG. 5 illustrates an example of functional blocks of the consent portal. The consent portal 10 includes a control unit 11 and a storage unit 12. The control unit 11 implements the function of the control unit 1a in FIG. 1, and the storage unit 12 implements the function of the storage unit 1b in FIG. 1.

The control unit 11 includes an update status/acquisition status management unit 11a, a data acquisition destination search unit 11b, a determination processing unit 11c, and an access permission issuing unit 11d.

The update status/acquisition status management unit 11a manages an update status of personal data of the resource server RS and an acquisition status of personal data of the client apparatus CL. The data acquisition destination search unit 11b generates a request route described later, which is a transfer route of a data request, and searches for a node as an acquisition destination of personal data.

The determination processing unit 11c determines whether or not the client apparatus CL has acquired updated data that has been updated, based on the update status and the acquisition status.

In a case where it is determined that the client apparatus CL has not acquired the updated data, the access permission issuing unit 11d issues an access permission for acquiring the updated data to the client apparatus CL. In a case where it is determined that the client apparatus CL has acquired the updated data, the access permission issuing unit 11d does not issue the access permission for acquiring the updated data to the client apparatus CL (stop issuing the access permission).

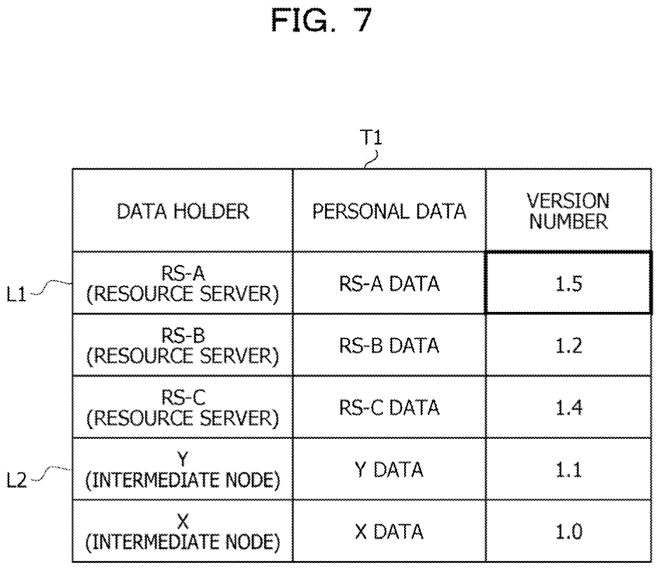

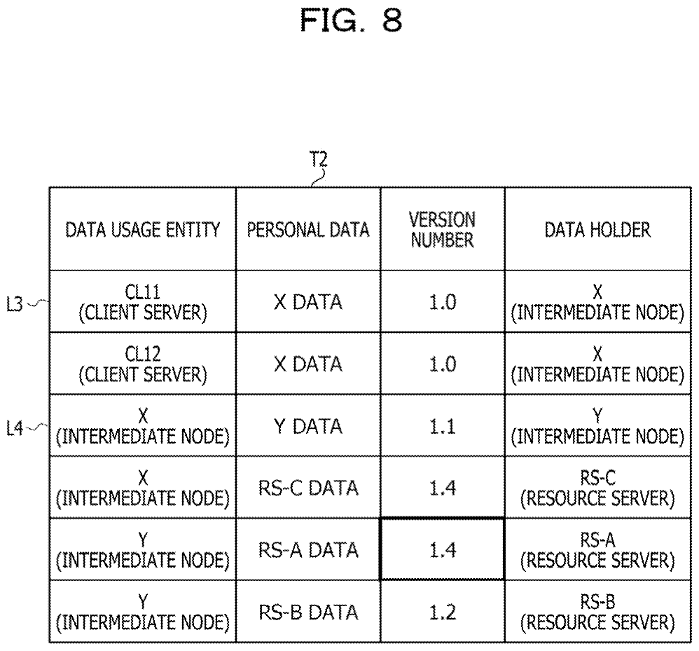

The storage unit 12 stores a personal data update status management table T1 in which an update status of data in the resource server RS or the intermediate node is registered, and stores a personal data acquisition status management table T2 in which an acquisition status of data in the client apparatus CL or the intermediate node is registered. Details of a table configuration will be described later with reference to FIGS. 7 and 8.

<Hardware>

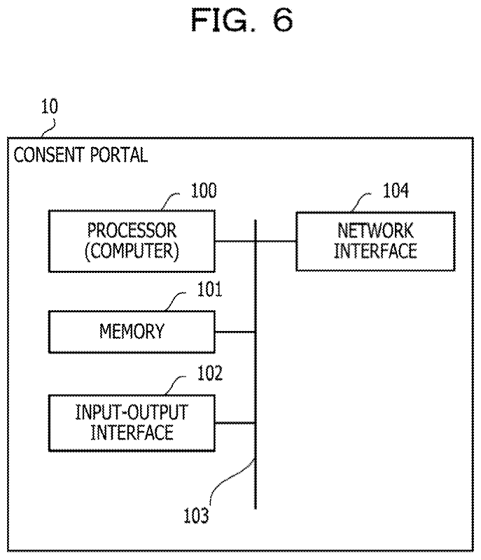

FIG. 6 illustrates an example of a hardware configuration of the consent portal. A processor (computer) 100 controls the entire consent portal 10. The processor 100 implements functions of the control unit 11.

A memory 101, an input-output interface 102, and a network interface 104 are coupled to the processor 100 via a bus 103.

The processor 100 may be a multiprocessor. The processor 100 is, for example, a central processing unit (CPU), a microprocessor unit (MPU), a digital signal processor (DSP), an application-specific integrated circuit (ASIC), or a programmable logic device (PLD). Further, the processor 100 may be a combination of two or more elements of a CPU, an MPU, a DSP, an ASIC, and a PLD.

The memory 101 implements functions of the storage unit 12 and is used as a main storage device of the consent portal 10. At least part of an operating system (OS) program and application programs that are executed by the processor 100 is temporarily stored in the memory 101. Further, the memory 101 also stores various kinds of data used in processing by the processor 100.

Further, the memory 101 is also used as an auxiliary storage device of the consent portal 10 and stores the OS program, the application programs, and various kinds of data. The memory 101 may include, as the auxiliary storage device, a semiconductor storage device such as a flash memory or a solid-state drive (SSD) and a magnetic recording medium such as a hard disk drive (HDD).

Examples of a peripheral device coupled to the bus 103 include the input-output interface 102 and the network interface 104. The input-output interface 102 may be coupled to an information input device such as a keyboard or a mouse and transmits a signal sent from the information input device to the processor 100.

Further, the input-output interface 102 also functions as a communication interface for coupling with the peripheral devices. For example, an optical drive device that uses laser light or the like to read data recorded on an optical disk may be coupled to the input-output interface 102. Examples of the optical disk include a Blu-ray Disc (registered trademark), a compact disc read-only memory (CD-ROM), a CD-recordable (R)/rewritable (RW), and the like.

Further, a memory device and a memory reader-writer may also be coupled to the input-output interface 102. The memory device is a recording medium having a function of communicating with the input-output interface 102. The memory reader-writer is a device that writes data to a memory card or reads data from the memory card. The memory card is a card-type recording medium.

The network interface 104 is coupled to a network and performs network interface control. For example, a network interface card (MC), a wireless local area network (LAN) card, or the like may be used as the network interface 104. Data received by the network interface 104 is output to the memory 101 or the processor 100.

With the above hardware configuration, the processing functions of the consent portal 10 may be realized. For example, the consent portal 10 may perform processing of the present disclosure by each of the processors 100 executing a predetermined program.

The consent portal 10 implements the processing functions of the present disclosure by, for example, executing a program recorded in a computer-readable recording medium. The program in which contents of processing to be executed by the consent portal 10 are described may be recorded in various recording media.

For example, the program to be executed by the consent portal 10 may be stored in the auxiliary storage device. The processor 100 loads at least a part of the program in the auxiliary storage device into the main storage device and executes the program.

Further, the program to be executed by the consent portal 10 may be recorded in a portable recording medium such as an optical disk, a memory device, and a memory card. The program stored in the portable recording medium may be executed, for example, after being installed in the auxiliary storage device under the control of the processor 100. Further, the processor 100 may read the program directly from the portable recording medium and execute the program.

Note that the hardware of the consent portal 10 described above may be applied to the resource server RS, the client apparatus CL, and the intermediate nodes.

<Table Configuration>

FIG. 7 illustrates an example of a personal data update status management table. The personal data update status management table T1 has a data holder, personal data, and a version number as items.

In the personal data update status management table T1, the resource servers RS and the intermediate nodes (here, the intermediate node plays a role of a data holder) are registered as the data holders, and the update status of personal data in each data holder is registered.

For example, in a column L1, (data holder, personal data, version number)=(RS-A, RS-A data, 1.5) is registered. For example, it is managed by the consent portal 10 that the personal data (RS-A data) of 1.5 version is registered to be owned by the resource server RS-A.

Further, in a column L2, (data holder, personal data, version number)=(Y, Y data, 1.1) is registered. For example, it is managed by the consent portal 10 that the personal data (Y data) of 1.1 version is registered to be owned by the intermediate node Y.

Here, in a case where personal data owned by the resource server RS and the intermediate node is updated, the resource server RS and the intermediate node notify the consent portal 10 of the updated contents. Based on the notified updated contents, the consent portal 10 updates the registration of the personal data update status management table T1.

FIG. 8 illustrates an example of a personal data acquisition status management table. The personal data acquisition status management table T2 has a data usage entity, personal data, a version number, and a data holder as items.

In the personal data acquisition status management table T2, the client apparatuses CL and the intermediate nodes (here, the intermediate node plays a role of a data usage entity) are registered as the data usage entities, and an acquisition status of personal data in each data usage entity is registered. Further, it is also registered from which data holder (resource server RS or intermediate node) the data usage entity has acquired personal data.

For example, in a column L3, (data usage entity, personal data, version number, data holder)=(CL11, X data, 1.0, X) is registered. For example, the consent portal 10 manages that the client apparatus CL11 has acquired personal data (X data) of 1.0 version from the intermediate node X.

Further, in a column L4, (data usage entity, personal data, version number, data holder)=(X, Y data, 1.1, Y) is registered. For example, the consent portal 10 manages that the intermediate node X has acquired personal data (Y data) of 1.1 version from the intermediate node Y.

Here, when the client apparatus CL and the intermediate node acquire personal data from the data holder that is an acquisition source described in the table, the client apparatus CL and the intermediate node notify the consent portal 10 of the acquired contents. Based on the notified acquired contents, the consent portal 10 updates the registration of the personal data acquisition status management table T2.

<Request Route>

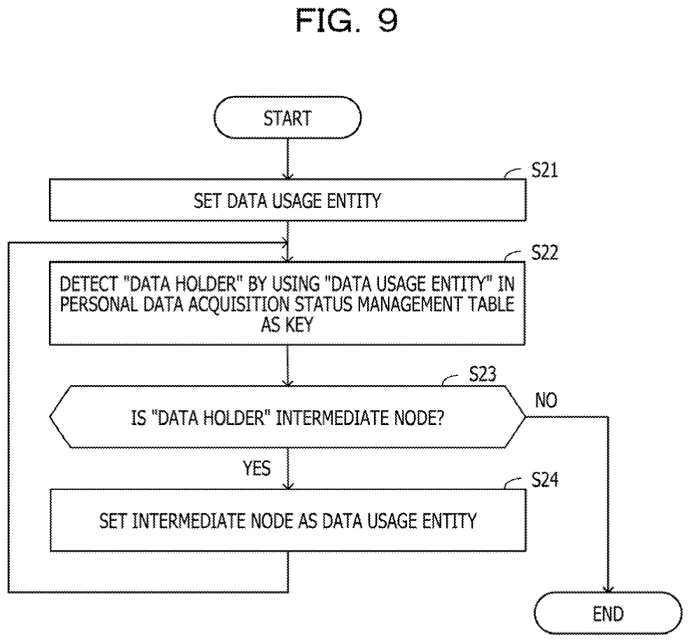

Next, generation of the request route (data acquisition request transfer route) in data acquisition destination search processing by the consent portal 10 is described with reference to FIGS. 9 to 12. When the data usage entity acquires personal data, the consent portal 10 refers to the personal data update status management table T1 and the personal data acquisition status management table T2 to generate a route (request route) of a data request from the data usage entity.

FIG. 9 is a flowchart illustrating an example of an operation of generating a personal data transfer route. Before generating the request route, the consent portal 10 first generates a personal data transfer route. The personal data transfer route is a transfer route of personal data from the client apparatus CL to a final data holder via the intermediate node.

In the processing of generating the personal data transfer route, the consent portal 10 repeatedly refers to a relationship between the “data usage entity” and the “data holder” in the personal data acquisition status management table T2 and searches for the final “data holder”, that is, a “data holder” that does not have an “intermediate node” or a “data holder” ahead of the data holder.

[Step S21] The control unit 11 sets a target data usage entity.

[Step S22] The control unit 11 detects a “data holder” by using the “data usage entity” in the personal data acquisition status management table T2 as a key.

[Step S23] The control unit 11 determines whether or not the “data holder” detected in step S22 is an intermediate node. In a case where the data holder is an intermediate node, the process proceeds to step S24, and in a case where the data holder is not an intermediate node (when the data holder is the resource server RS), the process ends.

[Step S24] The control unit 11 sets the intermediate node as a data usage entity. The process returns to step S22,

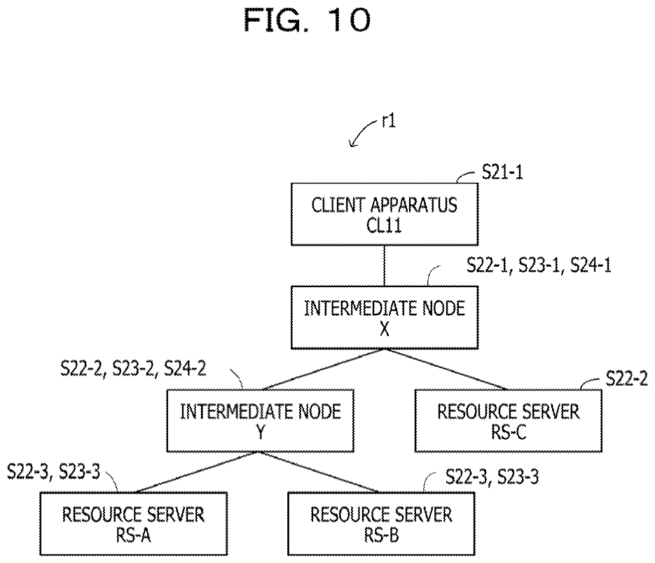

FIG. 10 illustrates an example of a personal data transfer route. FIG. 10 illustrates an example of a personal data transfer route generated by the processing described above with reference to FIG. 9.

In a personal data transfer route r1, the personal data acquired by the client apparatus CL11 is personal data owned by the intermediate node X. However, the personal data owned by the intermediate node X is obtained by processing personal data owned by the intermediate node Y and personal data owned by the resource server RS-C.

Further, the personal data may be updated earlier by the intermediate node X. For example, personal data may be updated in a node (the intermediate node Y in the example of FIG. 10) that transfers the personal data to the intermediate node X. In such a state, it is desirable that the intermediate node X processes the updated personal data to obtain the latest personal data and present the latest personal data to the client apparatus CL11.

Therefore, by generating a route from the client apparatus CL11 to the final data holder, it is possible to recognize the relationships between personal data and the respective nodes, such as which intermediate node the personal data is processed and the update status of the personal data.

Thus, the consent portal 10 generates, for example, the personal data transfer route r1 for recognizing the relationships between the personal data and the respective nodes from the client apparatus CL11 to the final data holder (resource servers RS-A and RS-B) as illustrated in FIG. 10.

[Step S21-1] The control unit 11 sets the client apparatus CL11 as a target data usage entity.

[Step S22-1] The control unit 11 detects a “data holder (intermediate node X)” by using the “data usage entity (CL11)” of the personal data acquisition status management table T2 as a key.

[Step S23-1] The control unit 11 determines that the detected “data holder” is an intermediate node X.

[Step S24-1] The control unit 11 sets the inter mediate node X as a data usage entity.

[Step S22-2] The control unit 11 detects “data holders (intermediate nodes Y and RS-C)” by using the “data usage entity (intermediate node X)” of the personal data acquisition status management table T2 as a key.

[Step S23-2] The control unit 11 determines that the intermediate node Y exists among the detected “data holders”.

[Step S24-2] The control unit 11 sets the intermediate node Y as a data usage entity.

[Step S22-3] The control unit 11 detects “data holders (RS-A and RS-B)” by using the “data usage entity (intermediate node V)” of the personal data acquisition status management table T2 as a key.

[Step S23-3] The control unit 11 determines that the intermediate node does not exist among the detected “data holders”. Thus, the resource servers RS-A and RS-B are detected as the final data holders.

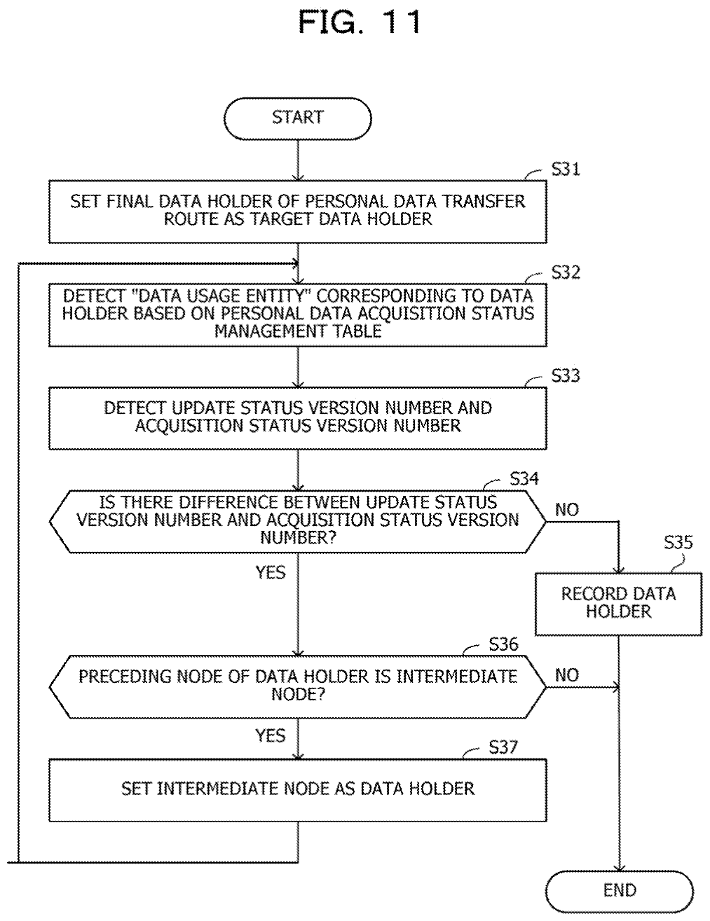

FIG. 11 is a flowchart illustrating an example of an operation of generating a request route. Based on the generated personal data transfer route, the control unit 11 generates a request route indicating to what extent a data request from the data usage entity is transmitted (relayed) in order to provide the data usage entity with the latest personal data.

[Step S31] The control unit 11 sets a final data holder of the generated personal data transfer route as a target data holder.

[Step S32] The control unit 11 detects a “data usage entity” corresponding to the set data holder based on the personal data acquisition status management table T2.

[Step S33] The control unit 11 detects a “version number” (update status version number) corresponding to the set data holder based on the personal data update status management table T1. Further, the control unit 11 detects a “version number” (acquisition status version number) corresponding to the “data usage entity” detected in step S32 based on the personal data acquisition status management table T2.

[Step S34] The control unit 11 determines whether or not there is a difference between the update status version number and the acquisition status version number. When there is no difference, the processing proceeds to step S35, and when there is a difference, the processing proceeds to step S36.

[Step S35] The control unit 11 records the node corresponding to the data holder and ends the processing.

[Step S36] The control unit 11 determines whether or not a preceding node of the set data holder (a node that transfers personal data to the set data holder) is an intermediate node in the personal data transfer route. When it is determined as an intermediate node, the process proceeds to step S37, and when it is not determined as an intermediate node, the process ends.

[Step 97] The control unit 11 sets the intermediate node as a data holder. The process returns to step S32.

As described above, in the request route generation processing of the control unit 11, in a case where the update status version number and the acquisition status version number are different upon searching from the final “data holder”, it is determined that the updated personal data has not been acquired in the data holder, and the data holder is recorded. Then, control is performed to transfer a data request to the recorded data holder.

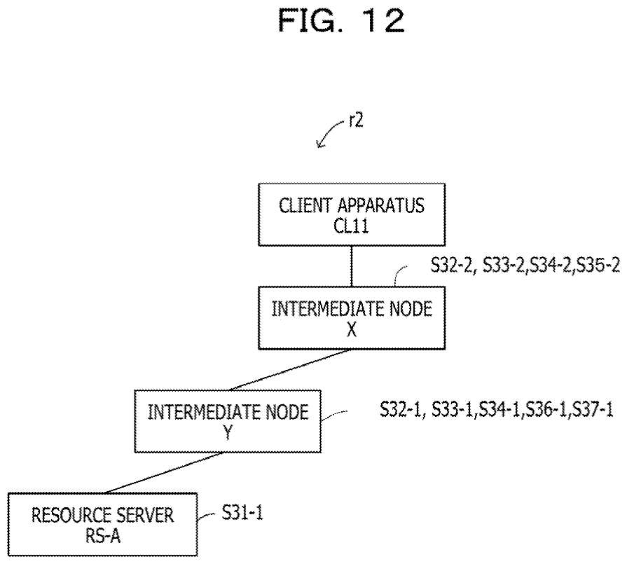

FIG. 12 illustrates an example of a request route. FIG. 12 illustrates an example of a request route generated by the processing described above with reference to FIG. 11.

In the tables illustrated in FIGS. 7 and 8, while the update status version number of the personal data in the resource server RS-A is version 1.5, the acquisition status version number of the intermediate node Y that acquires the personal data is version 1.4.

Thus, the consent portal 10 acquires the latest personal data from the resource server RS-A and generates a request route r2 that provides personal data to the client apparatus CL11 via the intermediate node Y and the intermediate node X. Note that since the other personal data is the latest, the request is controlled not to be relayed.

[Step S31-1] The control unit 11 sets a final data holder (resource server RS-A) from the personal data transfer route r1.

[Step S32-1] The control unit 11 detects a “data usage entity (intermediate node Y)” corresponding to the set data holder (resource server RS-A) based on the personal data acquisition status management table T2.

[Step S33-1] The control unit 11 detects an update status version number (version 1.5) corresponding to the set data holder (resource server RS-A) based on the personal data update status management table T1. Further, the control unit 11 detects an acquisition status version number (version 1.4) corresponding to the “data usage entity (intermediate node Y)” detected in step S32-1 based on the personal data acquisition status management table T2.

[Step S34-1] The control unit 11 determines that there is a difference between the update status version number and the acquisition status version number.

[Step S36-1] The control unit 11 determines that the preceding stage of the set data holder (resource server RS-A) is the intermediate node Y.

[Step S37-1] The control unit 11 sets the intermediate node Y as a data holder.

[Step S32-2] The control unit 11 detects a “data usage entity (intermediate node X)” corresponding to the set data holder (intermediate node Y) based on the personal data acquisition status management table T2.

[Step S33-2] The control unit 11 detects an update status version number (version 1.1) corresponding to the set data holder (intermediate node Y) based on the personal data update status management table T1. The control unit 11 detects an acquisition status version number (version 1.1) corresponding to the “data usage entity (intermediate node X)” detected in step S32-2 based on the personal data acquisition status management table T2.

[Step S34-2] The control unit 11 determines that there is no difference between the update status version number and the acquisition status version number.

[Step S35-2] The control unit 11 records the set data holder (intermediate node X). With such processing, a request route indicating to which node the data request is transferred may be generated.

<Communication Sequence>

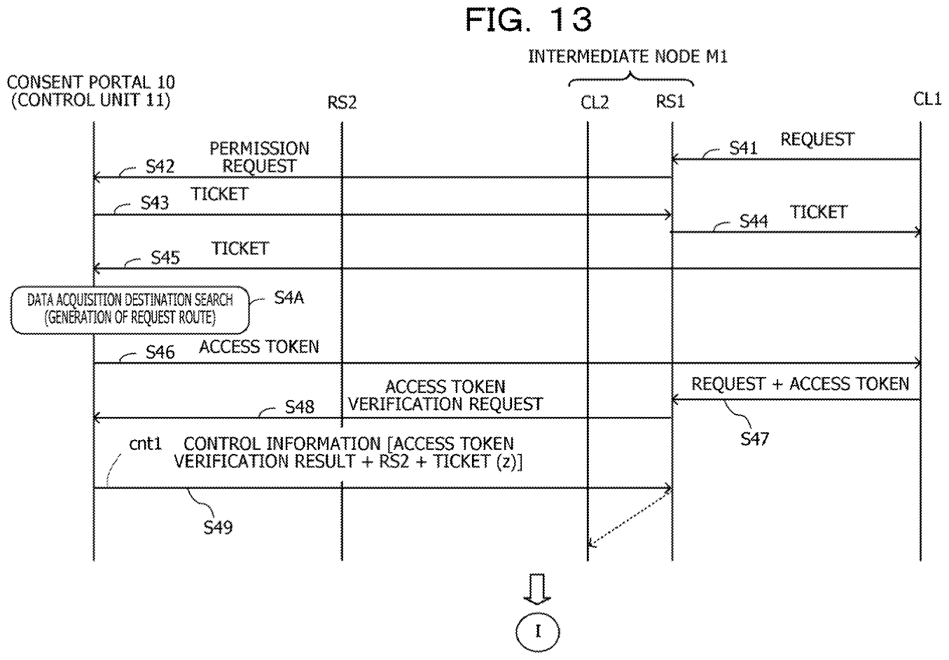

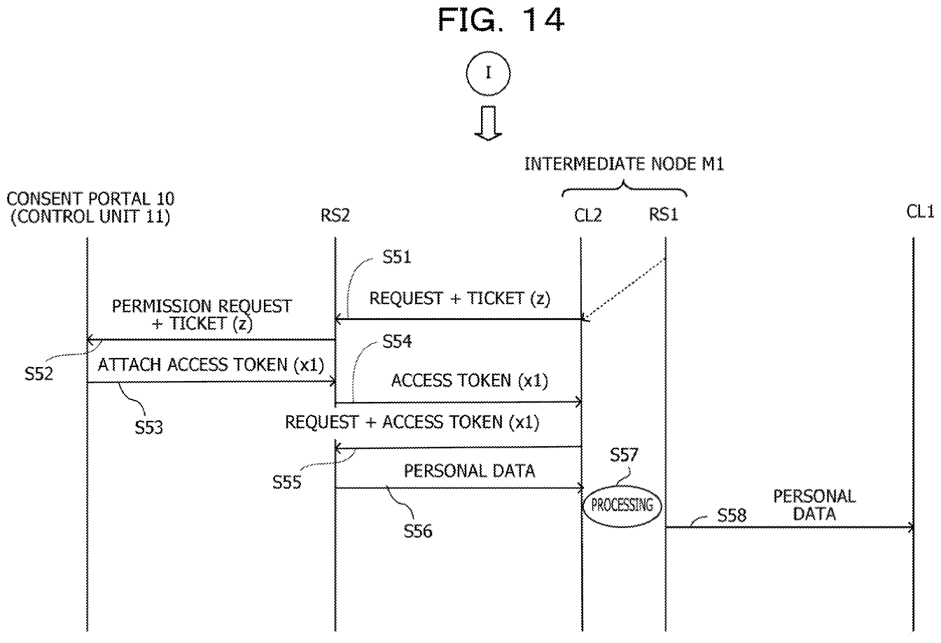

Next, a communication sequence of the consent portal 10 is described with reference to FIGS. 13 and 14. FIGS. 13 and 14 illustrate an example of a communication sequence. It is assumed that the intermediate node M1 has both functions of a resource server RS1 and a client apparatus CL2.

[Step S41] The client apparatus CL1 transmits a data request to the resource server RS1 by using the resource server RS1 in the intermediate node M1 as a data holder.

[Step S42] The resource server RS1 transmits a permission request for notifying that a data request has arrived from the client apparatus CL1 to the consent portal 10. At this time, the consent portal 10 authenticates the resource server RS1.

[Step S43] When the control unit 11 in the consent portal 10 authenticates the resource server RS1 as a valid data holder, the control unit 11 in the consent portal 10 issues a ticket to the resource server RS1.

[Step S44] The resource server RS1 transmits a response to the client apparatus CL1. At this time, the resource server RS1 transmits the ticket together with an address of the consent portal 10 to the client apparatus CL1.

[Step S45] The client apparatus CL1 transmits the ticket to the consent portal 10. At this time, the control unit 11 authenticates the client apparatus CL1, checks the ticket, and associates the resource server RS1 having transmitted the permission request with the client apparatus al.

[Step S4A] After the authentication of the client apparatus CL1 is completed, the control unit 11 performs a data acquisition destination search (generation of a request route). The control unit 11 determines whether or not the acquisition status of the personal data of the client apparatus CL1 is already the latest based on the request route. In a case where it is recognized that the acquisition status of the personal data of the client apparatus CL1 is the latest, a response indicating that the data request is unnecessary is sent to the client apparatus CL1. Further, when the acquisition status is not the latest, the subsequent sequence is continued.

[Step S46] When the control unit 11 authenticates the client apparatus CL1 as a valid data usage entity, the control unit 11 issues an access token (access permission) to the client apparatus CL1.

[Step S47] The client apparatus CL1 transmits a data request which the acquired access token is attached to the resource server RS1.

[Step S48] The resource server RS1 requests the consent portal 10 to verify the acquired access token.

Here, the control unit 11 determines a destination node to which the intermediate node M1 has to relay based on the request route. When the intermediate node M1 has the latest personal data, the control unit 11 instructs the intermediate node M1 to transmit the personal data.

In this example, since the resource server RS2 is in a status where the resource server RS2 has updated the personal data, the control unit 11 instructs the intermediate node M1 (resource server RS1 in the intermediate node M1) to relay the data request to the resource server RS2.

[Step S49] The control unit 11 transmits control information cnt1 to the resource server RS1. The control information cnt1 includes a verification result indicating validity of the access token, address information (RS2) of the resource server RS2, and a ticket (z) that defines communication authority between the intermediate node M1 and the resource server RS2.

As described above, when the access token is verified and is valid, the control unit 11 issues the resource server RS2 as a next relay destination and the ticket (z) to the resource server RS1. The subsequent communication sequence is performed by using the ticket (z) issued in the processing of step S49.

[Step S51] The client apparatus CL2 in the intermediate node M1 attaches the ticket (z) to the data and transmits the data to the resource server RS2.

[Step S52] The resource server RS2 transmits the permission request and the ticket (z) to the consent portal 10. At this time, the control unit 11 authenticates the resource server RS2.

[Step S53] After checking the ticket (z), the control unit 11 checks that the intermediate node M1 has made a request to the resource server RS2, and issues an access token (x1) (specific access permission) for the client apparatus CL2 to the resource server RS2.

[Step S54] The resource server RS2 transmits the access token (x1) to the client apparatus CL2. Here, the resource server RS2 also holds the access token (x1) passed to the client apparatus CL2.

[Step S55] The client apparatus CL2 makes a data request to the resource server RS2 by using the acquired access token (x1).

[Step S56] The resource server RS2 compares the held access token (x1) with the access token (xl) received in step S55, and when the access tokens are the same, determines that the data request is valid. Then, when it is determined that the data request is valid, the resource server RS2 passes personal data to the client apparatus CL2 in the intermediate node M1.

[Step S57] The intermediate node M1 processes the received personal data.

[Step S58] The resource server RS1 in the intermediate node M1 transmits the processed personal data to the client apparatus al. These operations may reduce communication traffic in the secondary distribution of the personal data.

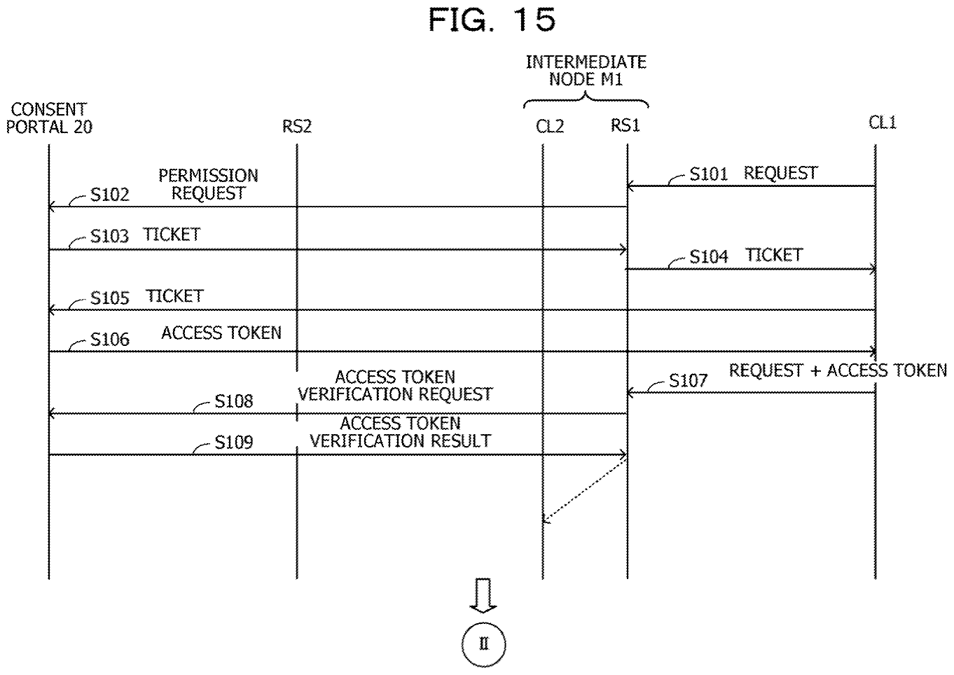

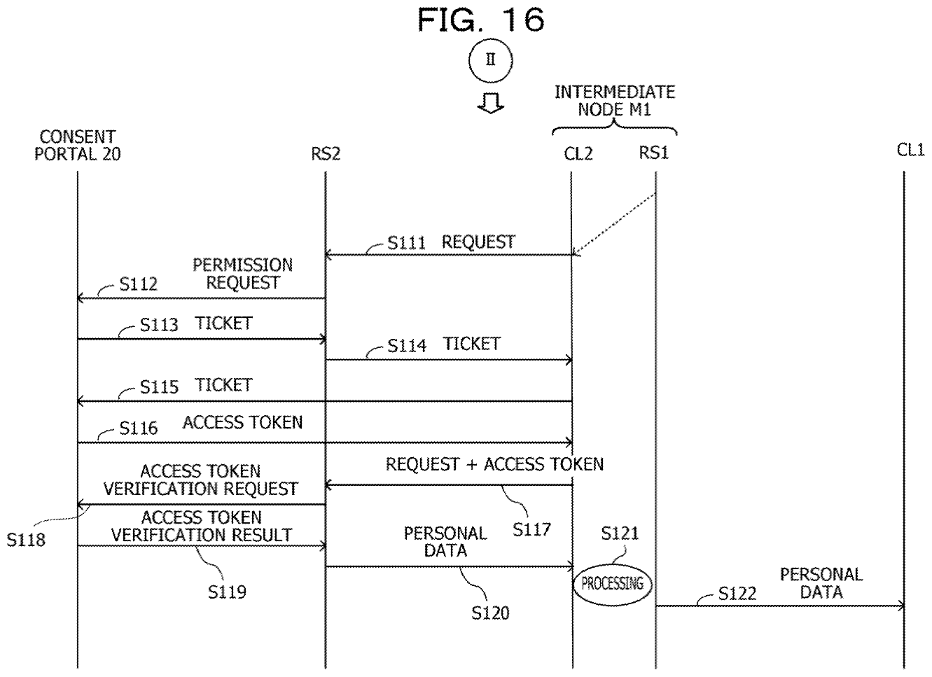

Here, in order to compare the communication sequence of the present disclosure in FIGS. 13 and 14 with the communication sequence in the existing UMA, the communication sequence in the existing UMA is illustrated in FIGS. 15 and 16.

FIGS. 15 and 16 illustrate an example of the communication sequence in the UMA.

[Step S101] The client apparatus al transmits a data request to the resource server RS1 by using the resource server RS1 as a data holder.

[Step S102] The resource server RS1 transmits a permission request for notifying that the data request has arrived from the client apparatus al to a consent portal 20 (it is assumed that the consent portal 20 is an existing consent portal having no function of the present disclosure). At this time, the consent portal 20 authenticates the resource server RS1.

[Step S103] When the consent portal 20 authenticates the resource server RS1 as a valid data holder, the consent portal 20 issues a ticket to the resource server RS1.

[Step S104] The resource server RS1 transmits a response to the client apparatus CL1. At this time, the resource server RS1 transmits the ticket together with an address of the consent portal 10 to the client apparatus CL1.

[Step S105] The client apparatus al transmits the ticket to the consent portal 20. At this time, the consent portal 20 authenticates the client apparatus CL1, checks the ticket, and associates the resource server RS1 having transmitted the permission request with the client apparatus CL1.

[Step S106] When the consent portal 20 authenticates the client apparatus CL1 as a valid data usage entity, the consent portal 20 issues an access token to the client apparatus CL1.

[Step S107] The client apparatus CL1 transmits a data request to which the acquired access token is attached to the resource server RS1.

[Step S108] The resource server RS1 requests the consent portal 20 to verify the acquired access token.

[Step S109] The consent portal 20 verifies the access token and transmits a result of the verification to the resource server RS1.

[Step S111] The client apparatus CL2 transmits the data request to the resource server RS2 by using the resource server RS2 as a data holder.

[Step S112] The resource server RS2 transmits a permission request for notifying that a data request has arrived from the client apparatus CL2 to the consent portal 20. At this time, the consent portal 20 authenticates the resource server RS2.

[Step S113] When the consent portal 20 authenticates the resource server RS2 as a valid data holder, the consent portal 20 issues a ticket to the resource server RS2.

[Step S114] The resource server RS2 transmits a response to the client apparatus CL2. At this time, the resource server RS2 transmits the ticket together with an address of the consent portal 20 to the client apparatus CL2.

[Step S115] The client apparatus CL2 transmits the ticket to the consent portal 20. At this time, the consent portal 20 authenticates the client apparatus CL2, checks the ticket, and associates the resource server RS2 having transmitted the permission request with the client apparatus CL2.

[Step S116] When the consent portal 20 authenticates the client apparatus CL2 as a valid data usage entity, the consent portal 20 issues an access token to the client apparatus CL2.

[Step S117] The client apparatus CL2 transmits a data request to which the acquired access token is attached to the resource server RS2.

[Step S118] The resource server RS2 requests the consent portal 20 to verify the access token.

[Step S119] The consent portal 20 verifies the access token and transmits a result of the verification to the resource server RS2.

[Step S120] The resource server RS2 passes personal data to the client apparatus CL2 in the intermediate node M1.

[Step S121] The intermediate node M1 processes the received personal data.

[Step S122] The resource server RS1 in the intermediate node M1 transmits the processed personal data to the client apparatus CL1.

As described above, in the communication sequence in the existing UMA, the processing of acquiring an access token and making a request is repeated two times. Thus, the intermediate node M1 communicates with the consent portal 20 in the respective roles of the data holder and the data usage entity, and communication traffic increases. On the other hand, in the communication sequence of the present disclosure, since communication is performed by partially merging the roles of the data holder and the data usage entity, it is possible to reduce communication traffic.

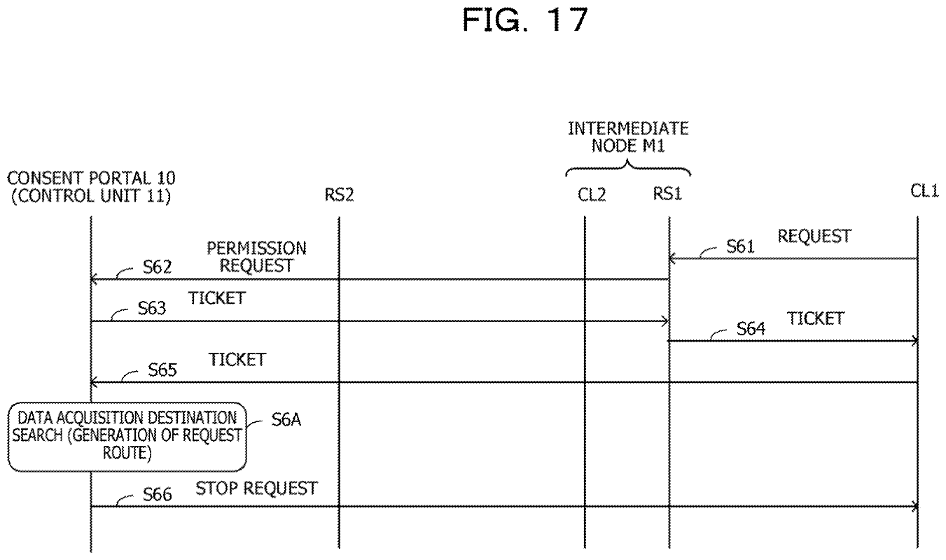

FIG. 17 illustrates an example of a communication sequence. FIG. 17 illustrates a communication sequence in a case where the client apparatus CL1 has the latest personal data.

[Step S61] The client apparatus CL1 transmits a data request to the resource server RS1 by using the resource server RS1 as a data holder.

[Step S62] The resource server RS1 transmits a permission request for notifying that the data request has arrived from the client apparatus al to the consent portal 10. At this time, the consent portal 10 authenticates the resource server RS1.

[Step S63] When the control unit 11 in the consent portal 10 authenticates the resource server RS1 as a valid data holder, the control unit 11 in the consent portal 10 issues a ticket to the resource server RS1.

[Step S64] The resource server RS1 transmits a response to the client apparatus CL1. At this time, the resource server RS1 transmits the ticket together with an address of the consent portal 10 to the client apparatus CL1.

[Step S65] The client apparatus CL1 transmits the ticket to the consent portal 10. At this time, the control unit 11 authenticates the client apparatus CL1, checks the ticket, and associates the resource server RS1 having transmitted the permission request with the client apparatus CL1.

[Step S6A] After the authentication of the client apparatus al is completed, the control unit 11 performs a data acquisition destination search (generation of a request route). The control unit 11 recognizes that the acquisition status of the personal data of the client apparatus CL1 is already the latest based on the request route.

[Step S66] The control unit 11 instructs the client apparatus CL1 to stop the data request.

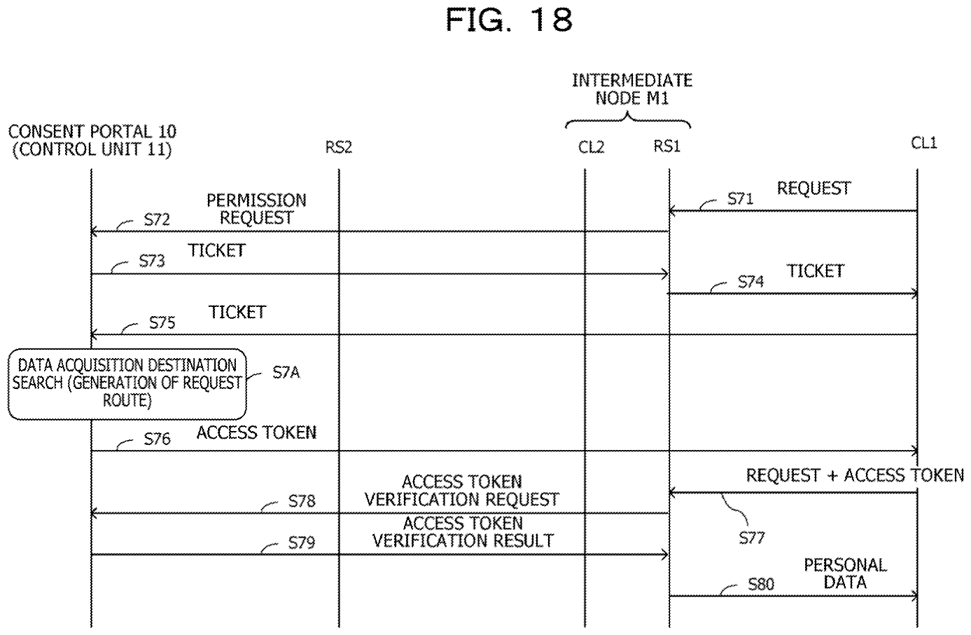

FIG. 18 illustrates an example of a communication sequence. FIG. 18 illustrates a communication sequence in a case where the resource server RS1 has the latest personal data.

[Step S71] The client apparatus CL1 transmits a data request to the resource server RS1 by using the resource server RS1 as a data holder.

[Step S72] The resource server RS1 transmits a permission request for notifying that the data request has arrived from the client apparatus CL1 to the consent portal 10. At this time, the consent portal 10 authenticates the resource server RS1.

[Step S73] When the control unit 11 in the consent portal 10 authenticates the resource server RS1 as a valid data, holder, the control unit 11 in the consent portal 10 issues a ticket to the resource server RS1.

[Step S74] The resource server RS1 transmits a response to the client apparatus CL1. At this time, the resource server RS1 transmits the ticket together with an address of the consent portal 10 to the client apparatus CL1.

[Step S75] The client apparatus CL1 transmits the ticket to the consent portal 10. At this time, the control unit 11 authenticates the client apparatus CL1, checks the ticket, and associates the resource server RS1 having transmitted the permission request with the client apparatus CL1.

[Step S7A] After the authentication of the client apparatus CL1 is completed, the control unit 11 performs a data acquisition destination search (generation of a request route). Based on the request route, the control unit 11 recognizes that the acquisition status of the personal data of the client apparatus CL1 is not the latest and the intermediate node M1 has the latest personal data. In this case, the subsequent sequence is continued.

[Step S76] When the control unit 11 authenticates the client apparatus CL1 as a valid data usage entity, the control unit 11 issues an access token to the client apparatus CL1.

[Step S77] The client apparatus CL1 transmits a data request to which the acquired access token is attached to the resource server RS1.

[Step S78] The resource server RS1 requests the consent portal 10 to verify the acquired access token.

[Step S79] The control unit 11 verifies the access token and transmits a verification result to the resource server RS1.

[Step S80] The resource server RS1 transmits the personal data to the client apparatus CL1.

### MODIFICATION EXAMPLE

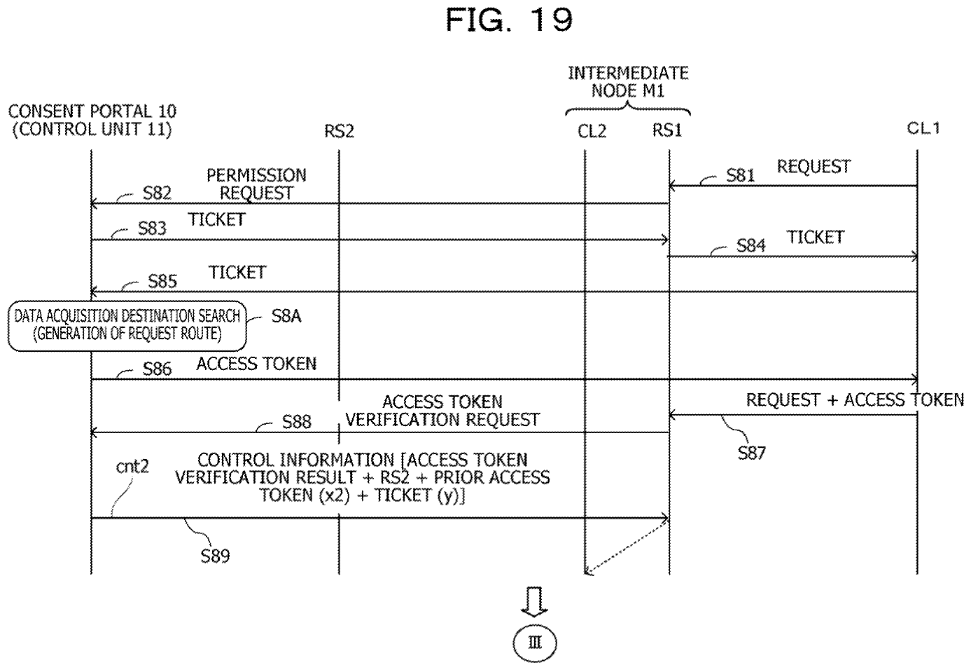

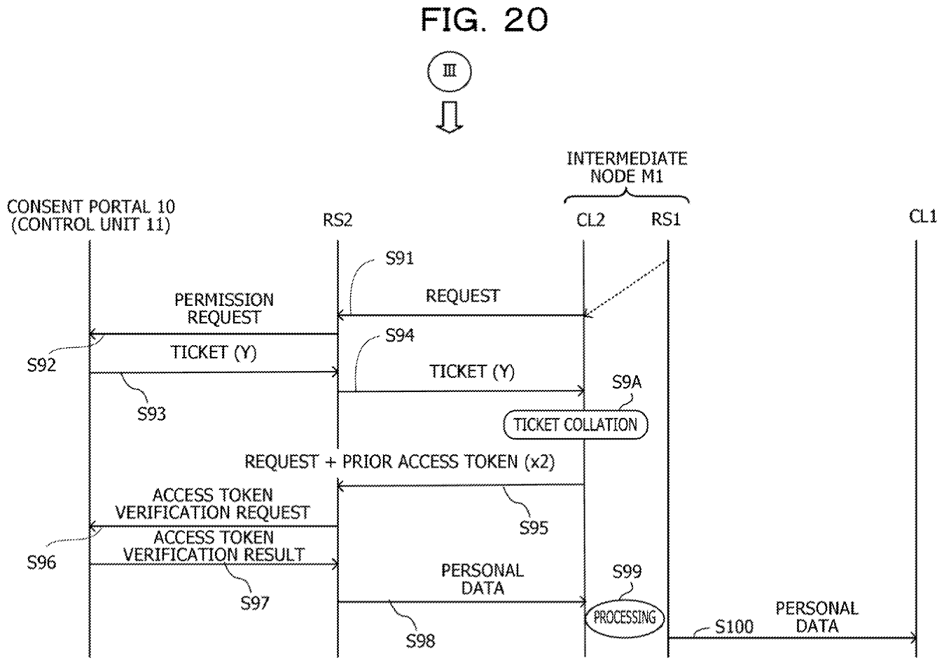

FIGS. 19 and 20 illustrate an example of a communication sequence of a modification example.

[Step S81] The client apparatus CL1 transmits a data request to the resource server RS1 by using the resource server RS1 as a data holder.

[Step S82] The resource server RS1 transmits a permission request for notifying that the data request has arrived from the client apparatus CL1 to the consent portal 10. At this time, the consent portal 10 authenticates the resource server RS1.

[Step S83] When the control unit 11 in the consent portal 10 authenticates the resource server RS1 as a valid data holder, the control unit 11 in the consent portal 10 issues a ticket to the resource server RS1.

[Step S84] The resource server RS1 transmits a response to the client apparatus CL1. At this time, the resource server RS1 transmits the ticket together with an address of the consent portal 10 to the client apparatus CL1.

[Step S85] The client apparatus CL1 transmits the ticket to the consent portal 10. At this time, the control unit 11 authenticates the client apparatus CL1, checks the ticket, and associates the resource server RS1 having transmitted the permission request with the client apparatus CL1.

[Step S8A] After the authentication of the client apparatus CL1 is completed, the control unit 11 performs a data acquisition destination search (generation of a request route). The control unit 11 recognizes that the acquisition status of the personal data of the client apparatus CL1 is not the latest based on the request route, and continues the subsequent sequence.

[Step S86] When the control unit 11 authenticates the client apparatus CL1 as a valid data usage entity, the control unit 11 issues an access token to the client apparatus CL1.

[Step S87] The client apparatus CL1 transmits a data request which the acquired access token is attached to the resource server RS1.

[Step S88] The resource server RS1 requests the consent portal 10 to verify the acquired access token.

[Step S89] The control unit 11 transmits control information cnt2 to the resource server RS1. The control information cnt2 includes a verification result indicating validity of the access token, address information (RS2) of the resource server RS2, and a prior access token (x2) for the intermediate node M1 to acquire the latest personal data from the resource server RS2, and a ticket (y) defining communication authority between the intermediate node M1 and the resource server RS2.

As described above, when the access token is verified and is valid, the control unit 11 issues the resource server RS2 as a next relay destination, the prior access token (x2), and the ticket (y) for the resource server RS2 in advance.

[Step S91] The client apparatus CL2 transmits a data request to the resource server RS2 by using the resource server RS2 as a data holder.

[Step S92] The resource server RS2 transmits a permission request for notifying that the data request has arrived from the client apparatus CL2 to the consent portal 10. At this time, the consent portal 10 authenticates the resource server RS2.

[Step S93] When the consent portal 10 authenticates the resource server RS2 as a valid data holder, the control unit 11 issues a ticket to the resource server RS2.

[Step S94] The resource server RS2 transmits a response to the client apparatus CL2. At this time, the resource server RS2 transmits the ticket together with the address of the consent portal 10 to the client apparatus CL2.

[Step S9A] The client apparatus CL2 collates the ticket (y) acquired from the consent portal 10 with the ticket (y) acquired from the resource server RS2, and when the ticket (y) acquired from the consent portal 10 and the ticket (y) acquired from the resource server RS2 are the same, validates the prior access token (x2) acquired in advance and makes a request to the resource server RS. In a case where a different ticket is received, the ticket is sent to the consent portal 10.

[Step S95] The client apparatus CL2 transmits a data request including the prior access token (x2) to the resource server RS2.

In this manner, the intermediate node M1 holds the ticket (y) acquired in step S89, and then collates the ticket (y) acquired in step S89 with the ticket (y) sent from the resource server RS2. In a case where the ticket (y) acquired in step S89 and the ticket (y) sent from the resource server RS2 are the same, it is determined that the acquired prior access token (x2) is valid. Then, in a case where it is determined to be valid, the intermediate node M1 makes a request to the resource server RS2 with the prior access token (x2).

[Step S96] The resource server RS2 requests the consent portal 10 to verify the prior access token (x2).

[Step S97] The control unit 11 verifies the prior access token (x2) and transmits the result to the resource server RS2.

[Step S98] The resource server RS2 passes personal data to the client apparatus CL2 in the intermediate node M1.

[Step S99] The intermediate node M1 processes the received personal data.

[Step S100] The resource server RS1 in the intermediate node M1 transmits the processed personal data to the client apparatus CL1.

In this manner, in a case of a modification example, the intermediate node M1 holds the ticket (y), and then the ticket (y) acquired in step S89 is collated with the ticket (y) sent from the resource server RS2. Then, when the ticket (y) acquired in step S89 and the ticket (y) sent from the resource server RS2 are the same, the acquired prior access token (x2) is validated, and a data request is made to the resource server RS2 with the prior access token (x2). This operation may also reduce communication traffic.

As described above, according to the present disclosure, in a data distribution environment, in a case where a data usage entity determines that updated data has not been acquired based on an update status and an acquisition status of data, an access permission for data acquisition is issued to the data usage entity. This may reduce communication traffic. Note that in the second embodiment, a case where the present disclosure is applied to the distribution environment of personal data has been described, but the present disclosure may be flexibly applied to the distribution of various types of data without being limited to the personal data.

The communication apparatus 1 and the consent portal 10 of the present disclosure described above may be achieved by a computer. In this case, there is provided a program in which processing content of functions to be included in the communication apparatus 1 is described and the consent portal 10. By executing the program on the computer, the processing function described above is implemented over the computer.

The program in which contents of processing is described may be recorded in a computer-readable recording medium. Examples of the computer-readable recording medium include a magnetic storage unit, an optical disk, a magneto-optical recording medium, a semiconductor memory, and the like. Examples of the magnetic storage unit include a hard disk drive (HDD), a floppy disk (FD), a magnetic tape, and the like. Examples of the optical disk include a CD-ROM/RW and the like. Examples of the magneto-optical recording medium include a magneto optical (MO) disk and the like.

When a program is to be distributed, for example, portable recording media such as CD-ROMs on which the program is recorded are sold. Further, the program may be stored in a storage unit of a server computer and transferred from the server computer to another computer via a network.

For example, the computer executing the program stores, in its storage unit, a program recorded on the portable recording medium or a program transferred from the server computer. Then, the computer reads the program from its storage unit and executes processing in accordance with the program. Note that the computer may also read the program directly from the portable recording medium and execute processing in accordance with the program.

Further, each time a program is transferred from a server computer coupled via a network to a computer, the computer may sequentially execute processing in accordance with the received program. Further, at least a part of the processing functions described above may be achieved by an electronic circuit such as a DSP, an ASIC, and a PLD.

Hereinabove, although embodiments have been illustrated, the configuration of each unit illustrated in the embodiments may be replaced with another unit having the same or similar functions. Further, any other components and processes may be added. Furthermore, any two or more configurations (features) of the embodiments described above may be combined together.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a communication program for causing a computer to execute processing, the processing comprising:
managing an update status of data owned by a data-owning apparatus;
managing an acquisition status of the data acquired by a data-using apparatus through the data-owning apparatus;
determining, when a data acquisition request from the data-using apparatus is detected, whether the data-using apparatus has acquired updated data that has been updated, based on the update status and the acquisition status; and
issuing an access permission for acquiring the updated data to the data-using apparatus in a case where it is determined that the data-using apparatus has not acquired the updated data.

2. The non-transitory computer-readable storage medium according to claim 1, the processing further comprising:
stopping, in a case where it is determined that the data-using apparatus has acquired the updated data, issuance of the access permission for acquiring the updated data to the data-using apparatus.

3. The non-transitory computer-readable storage medium according to claim 1, the processing further comprising:
in a case where an intermediate apparatus that has both functions of owning and acquiring the data is disposed between the data-owning apparatus and the data-using apparatus, and the data-using apparatus acquires the updated data via the intermediate apparatus,
further managing the update status and the acquisition status of the data of the intermediate apparatus;
transmitting, in a case where it is detected that the intermediate apparatus owns the updated data, a verification result indicating validity of the access permission to the intermediate apparatus, and causing the intermediate apparatus to transmit the updated data to the data-using apparatus; and
transmitting, in a case where it is detected that the data-owning apparatus owns the updated data, control information for performing communication between the data-owning apparatus and the intermediate apparatus to the intermediate apparatus, causing the intermediate apparatus to acquire the updated data from the data-owning apparatus based on the control information, and causing the intermediate apparatus to transmit the updated data to the data-using apparatus.

4. The non-transitory computer-readable storage medium according to claim 3,
wherein the control information includes the verification result indicating validity of the access permission, address information of the data-owning apparatus, and ticket information for defining communication authority between the intermediate apparatus and the data-owning apparatus.

5. The non-transitory computer-readable storage medium according to claim 4,
wherein, upon receiving the control information, the intermediate apparatus transmits the data acquisition request and the ticket information to the data-owning apparatus detected from the address information, and
the processing further comprises
issuing, in a case where the ticket information transmitted via the data owning apparatus is received, a specific access permission for acquiring the updated data from the data-owning apparatus to the intermediate apparatus, and
causing the intermediate apparatus to acquire the updated data from the data-owning apparatus based on the specific access permission, and causing the intermediate apparatus to transmit the updated data to the data-using apparatus.

6. The non transitory computer-readable storage medium according to claim 3,
wherein the control information includes a verification result indicating validity of the access permission, address information of the data-owning apparatus, a prior access permission for the intermediate apparatus to acquire the updated data from the data-owning apparatus, and ticket information for defining communication authority between the intermediate apparatus and the data-owning apparatus.

7. The non-transitory computer-readable storage medium according to claim 6,
wherein, upon receiving the control information, the intermediate apparatus transmits the data acquisition request to the data-owning apparatus, and
the processing further comprises
receiving a permission request for notifying that the data-owning apparatus has received the data acquisition request,
causing, in a case where the ticket information is transmitted to the intermediate apparatus via the data-owning apparatus, and the ticket information transmitted to the intermediate apparatus and the ticket information held by the intermediate apparatus are collated by the intermediate apparatus, and the ticket information is the same, the prior access permission held by the intermediate apparatus to be valid, and
causing the intermediate apparatus to acquire the updated data from the data-owning apparatus based on the prior access permission, and causing the intermediate apparatus to transmit the updated data to the data-using apparatus.

8. The non-transitory computer-readable storage medium according to claim 1, the processing further comprising:
in a case where an intermediate apparatus that has both functions of owning and acquiring the data is disposed between the data-owning apparatus and the data-using apparatus,
setting the data-owning apparatus that owns the updated data as a data holder,
detecting a first intermediate apparatus that acquires the updated data from the data-owning apparatus, and
repeatedly performing, in a case where there is a difference between the update status of the data-owning apparatus and the acquisition status of the first intermediate apparatus and a second intermediate apparatus that acquires the updated data from the first intermediate apparatus is coupled to the first intermediate apparatus, control to set the first intermediate apparatus as a new data holder, and generating a data acquisition request transfer route that is a route through which the data acquisition request is transferred.

9. A computer-based method comprising:
managing an update status of data owned by a data-owning apparatus
managing an acquisition status of the data acquired by a data-using apparatus through the data-owning apparatus;
determining, when a data acquisition request from the data-using apparatus is detected, whether the data-using apparatus has acquired updated data that has been updated, based on the update status and the acquisition status; and
issuing an access permission for acquiring the updated data to the data-using apparatus in a case where it is determined that the data-using apparatus has not acquired the updated data.

10. A communication apparatus comprising:
a memory; and
a processor coupled to the memory, the processor being configured to perform processing, the processing including:
managing an update status of data owned by a data-owning apparatus;
managing an acquisition status of the data acquired by a data-using apparatus through the data-owning apparatus;
determining, when a data acquisition request from the data-using apparatus is detected, whether the data-using apparatus has acquired updated data that has been updated, based on the update status and the acquisition status; and
issuing an access permission for acquiring the updated data to the data-using apparatus in a case where it is determined that the data-using apparatus has not acquired the updated data.
